(19) United States
(12) Patent Application Publication
(10) Pub. No.: US 2013/0101705 A1
(43) Pub. Date: Apr. 25, 2013

(54) COFFEE EXTRACT COMPRISING A MULTIVALENT ION

(71) Applicants: Alexander A. Sher, Dublin, OH (US); Deepak Sahai, Dublin, OH (US); Paul Lietke, Chicago, IL (US)

(72) Inventors: Alexander A. Sher, Dublin, OH (US); Deepak Sahai, Dublin, OH (US); Paul Lietke, Chicago, IL (US)

(73) Assignee: NESTEC S.A., Vevey (CH)

(21) Appl. No.: 13/642,248

(22) PCT Filed: Apr. 14, 2011
(86) PCT No.: PCT/EP2011/055922

§ 371 Date: Dec. 31, 2012

(30) Foreign Application Priority Data
Apr. 21, 2010 (US) 61326461

(51) Int. Cl. A23F 5/42

(52) U.S. Cl. CPC A23F 5/42
USPC 426/74; 426/594; 426/432

(57) ABSTRACT

The present invention relates to a coffee extract with improved foaming properties, which comprises a multivalent ion ant to methods of producing a coffee extract of the invention and uses thereof.

### FIELD OF THE INVENTION

The present invention relates to a coffee extract with improved foaming properties, which comprises a multivalent ion.

### BACKGROUND

The presence of a fine foam layer, so-called crema, is important for the consumer perception of many coffee beverages, e.g. espresso. The volume, stability, mouthfeel and texture of this foam layer may be important for the consumers liking of the product. The foam may be produced during the extraction or brewing of the coffee as in a conventional espresso machine wherein roast and ground coffee beans are extracted under pressure, or in the case of soluble coffee products it may be produced during dissolution of the dry powder in water. There is thus an interest in producing coffee extracts with good foaming properties. WO 2009/040249 (Nestec S. A.) describes a method of producing a dry soluble coffee extract that produces good crema upon dissolution. There is still a desire to improve the foaming properties of coffee extracts.

Minerals are important for the physiological function of human beings. Calcium and magnesium are e.g. important for building and maintaining bone structure. Since the body does not produce minerals it is totally dependent on external supply hereof, and it is recognised that many people do not get an adequate intake of many minerals, including calcium and magnesium. There is thus a desire to increase intake of many minerals, e.g. through fortification of daily food and beverage products.

### SUMMARY OF THE INVENTION

The inventors have found that addition of a multivalent ion to a coffee extract improves the foaming properties of the coffee extract. Accordingly, the present invention relates to a coffee extract comprising at least 1 milligram of a multivalent ion per gram of coffee solids. In further embodiments the invention relates to a method of producing a coffee extract, and to use of a coffee extract.

### BRIEF DESCRIPTION OF THE FIGURES

FIG. 1 shows the effect of calcium chloride and zinc chloride addition on the stiffness of the foam of a coffee extract. Results are from example 3 described herein.

### DETAILED DESCRIPTION OF THE INVENTION

According to the present invention a coffee extract with improved foaming properties is provided. The coffee extract of the invention comprises at least 1 milligram of a multivalent ion per gram of coffee solids. In a preferred embodiment the coffee extract comprises at least 10 milligram, more preferred as at least 50 milligram, and even more preferred at least 100 milligram of a multivalent ion per gram of coffee solids. The coffee extract of the invention may e.g. comprise between 10 milligram and 200 milligram, such as between 50 milligram and 200 milligram, or between 100 milligram and 200 milligram of a multivalent ion per gram of coffee solids.

A multivalent ion according to the invention is any multivalent ion suited for addition to a coffee extract. By a multivalent ion is meant an ion with at least 2 valences, such as e.g. divalent and trivalent ions. Divalent ions are preferred. The multivalent ions may be either cations (positively charged) or anions (negatively charged). Multivalent cations are preferred. Preferred multivalent ions of the invention are ions of calcium, zinc, magnesium, and iron, and combinations thereof, especially calcium (II), magnesium (II), zinc (II), iron (II) and iron (III).

The coffee extract of the invention may be any extract obtained by extracting coffee beans with water. The coffee beans may be roast or green (raw, unroasted coffee beans) and they may be whole beans or beans that are ground before extraction. The coffee beans being extracted may be of any variety such as Robusta or Arabica, or combinations thereof. The coffee extract may be in liquid form, e.g. as a concentrated coffee extract or it may be in dry form. A dry coffee extract may be produced by drying a liquid coffee extract, e.g. by spray drying or freeze drying, and may be in any form such as e.g. in the form of a powder, granulate, tablet, or the like.

The presence of oil and fats may have a detrimental effect on the foaming properties of coffee, accordingly a coffee extract of the invention preferably comprises les than 1.5% (weight/weight) of oils, and furthermore the amount of mono- and diglycerides is preferably below 1% (weight/weight), and the amount of free fatty acids is preferably below 0.1%.

In a preferred embodiment, the coffee extract of the invention is a dried soluble coffee product. Dried soluble coffee products are well known in the art for preparation of a coffee beverage by dissolving the product in a hot or cold liquid such as water or milk. By a dried soluble coffee product is meant a dry coffee extract in solid, e.g. powdered, form which contains no or only a minor amount of water, such as e.g. below 5% water (weight/weight). A dry soluble coffee extract may be produced with a structure that increases the volume of foam produced when the product is dissolved. This may be achieved e.g. by injecting a gas into the liquid coffee extract just before it is being spray dried to produce a powder with fine pores containing gas. Such a method is e.g. disclosed in WO 2009/040249 (Nestec S. A.). Other methods for producing coffee powders with a structure that increases the amount of foam are e.g. disclosed in WO 2009/059938 (Nestec S. A.) and WO 2009/080596 (Nestec S. A.). Such methods may preferably be applied in the production of a dried soluble coffee product of the invention.

A coffee extract of the invention may be produced by a method comprising: a) extracting coffee beans with water to obtain an aqueous coffee extract; and b) adding a multivalent ion to the coffee extract in an amount of at least 1 milligram per gram of coffee solids. Coffee beans may be extracted with water in any suitable way, methods for aqueous extraction of coffee beans are well known in the art, e.g. for the production of soluble coffee. Before extraction aroma may be recovered from the coffee beans, e.g. by the method of WO 02/34063 (Société des Produits Nestlé S.A.), and the aroma may be added back to the coffee extract at a later stage of processing as is well known in the production of soluble coffee. According to the invention a multivalent ion is added to the coffee extract. A multivalent ion may be added in any suitable amount to achieve improved foam properties, e.g. in an amount sufficient to improve foam volume, foam stability, and or foam stiffness. In a preferred embodiment a multivalent ion is added in an amount of in an amount of at least 10 milligram per gram of coffee solids, such as at least 20 milligram, or at least 50 milligram per gram of coffee solids. Preferably a multivalent ion is added in an amount of between 1 milligram and 200 milligram per gram of coffee solids, such as between 10 milligram and 200 milligram, or between 50 milligram and 200 milligram per gram of coffee solids. The multivalent ion is preferably added to the liquid aqueous coffee extract, and the liquid coffee extract may have any concentration of coffee solids suitable for the intended use of the coffee extract, preferably the concentration of coffee solids in between 0.5% and 80% (weight/weight). The desired concentration of coffee solids may be achieved by adapting the extraction conditions accordingly and/or by diluting or concentrating the coffee extract after extraction. Concentration of the coffee extract may e.g. be performed by evaporation or filtration, e.g. reverse osmosis. The multivalent ion may be added in any suitable form. Usually the multivalent ion will be added in the form of a salt. Any suitable salt may be used, such as e.g. a chloride, oxide, carbonate, sulfate, lactate, and/or gluconate. Preferred salts are calcium oxide, calcium lactate, calcium hydroxide, calcium chloride, calcium carbonate, calcium gluconate, zinc sulfate, magnesium chloride, magnesium sulphate, and combinations thereof. A source of ion could e.g. be made by interaction between respective acid-base combinations, or from any dissociating compound resulting in the desired ions. To facilitate the mixing of a salt into a liquid coffee extract, the salt may be dissolved or suspended, e.g. in water or in a minor part of the liquid coffee extract, and the solution or suspension may be added to the coffee extract. In one embodiment of the invention the method of producing a coffee extract further comprises drying the coffee extract after addition of a multivalent ion to produce a dry soluble coffee product. The coffee extract may be dried in any suitable way, e.g. by spray drying or freeze drying. Methods for drying liquid coffee extracts are well known in the art of soluble coffee production.

The multivalent ion of the coffee extract of the invention is preferably not derived from milk. Hereby is meant that the multivalent ion preferably has not been obtained from milk, and/or that the multivalent ion is not added together with a milk product or component derived from milk. In a preferred embodiment, the coffee extract of the invention does not comprise milk solids. By milk solids is meant any compound or component derived from milk, such as e.g. milk protein, milk fat, and/or milk sugar, except water.

In a further preferred embodiment, a coffee extract of the invention consists of coffee solids and one or more multivalent ion. Hereby is meant that the coffee extract only comprises solids derived from a coffee plant, and one or more multivalent ions, and is free, or substantially free, from other non-coffee components, except water.

A coffee extract according to the invention has increased foam properties compared to a similar coffee extract produced by conventional methods. Foam properties is e.g. the volume of foam produced upon foaming the coffee extract, e.g. by injecting gas, air or steam into the liquid extract, or by stirring a liquid extract. For a dry soluble coffee product foam volume may e.g. be determined as the volume of foam created when the product is dissolved in a hot or cold liquid such as water or milk, or the volume of foam created when the dissolved extract is foamed e.g. by injecting gas, air or steam into a solution of the coffee extract, or by stirring the solution. The stability of the foam is also an important property and may e.g. be measured by measuring the speed of decrease of the foam volume over time. Other important foam properties are the stiffness and texture of the foam and organoleptic properties such as the visual appearance and mouthfeel.

### EXAMPLES

### Example 1

An aqueous coffee extract was produced by passing water and steam at elevated temperatures under pressure through bed of roast and ground coffee. Calcium chloride (at varying amounts—see table 1) was added to the extract. Further, nitrogen was incorporated under pressure into the extract by injecting nitrogen through fine pores into the extract just before drying. The calcium fortified extract was spray dried resulting in a powder with encapsulated gas.

### Foamability

Foamability was measured as initial foam volume obtained on reconstitution of 2% of coffee in hot water. Results are presented as percentage as compared to that of the reference without added calcium.

### Foam Stability

Foam stability was measured as percentage of foam volume lost 5 min after reconstituting the beverage.

All measurements for foamability and foam stability were performed in triplicate and the average reported.

The results are shown in table 1.

TABLE 1
The effect of calcium addition on coffee extract
foamability and foam stability.

| | Foamability, % | Foam stability, % |
|---|---|---|
| Control | 100 | 100 |
| CaCl₂, 0.5% | 116.7 | 114.7 |
| CaCl₂, 1% | 119.8 | 120.3 |
| CaCl₂, 2.5% | 126.8 | 131.8 |
| CaCl₂, 5.0% | 139.9 | 139.3 |
| CaCl₂, 10.0% | 157.9 | 157.7 |

### Example 2

An aqueous coffee extract was produced as described in example 1 and zinc chloride was added in the same manner as calcium chloride in example 1.

Foamability and foam stability was measured as described in example 1.

The results are shown in table 2.

TABLE 2
The effect of zinc addition on coffee extract
foamability and foam stability.

| | Foamability, % | Foam stability, % |
|---|---|---|
| Control | 100 | 100 |
| ZnCl₂, 0.5% | 122.4 | 112.4 |
| ZnCl₂, 1.0% | 128.5 | 129.6 |
| ZnCl₂, 2.5% | 136.1 | 131.1 |
| ZnCl₂, 5.0% | 153.7 | 139.0 |
| ZnCl₂, 10.0% | 158.5 | 141.7 |

### Example 3

An aqueous extract of coffee was produced as described in example 1. Calcium chloride and zinc chloride, respectively, was added to samples of the extract as described in examples 1 and 2 ion varying amounts.

### Foam Stiffness

Foam stiffness was measured as time in seconds required for a ¼ inch diameter acrylic sphere (gently placed over the foam surface) to sink until disappearance. Al measurements were performed in triplicate and the average reported.

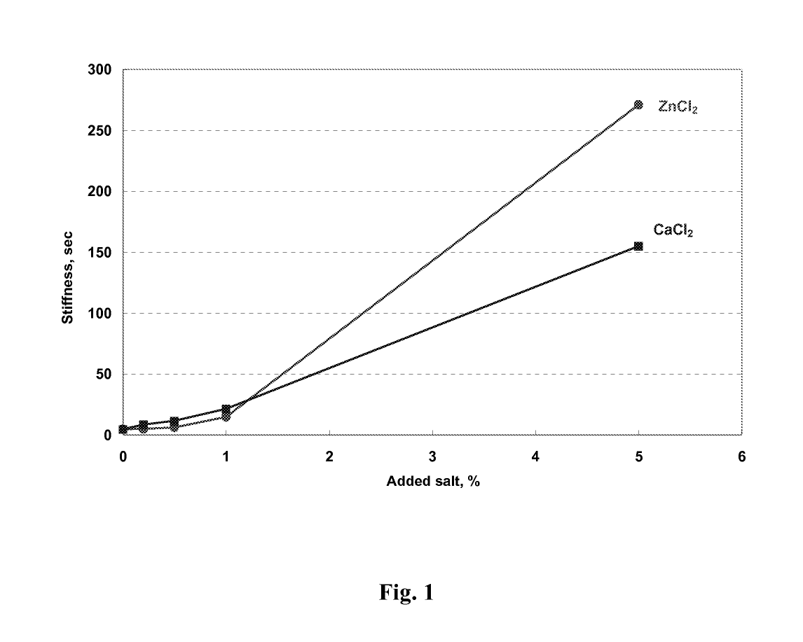

The results are shown in FIG. 1.

### Example 4

Calcium fortified self-foaming instant coffee powder was prepared using calcium chloride salt.

First, 10 g of calcium chloride was dissolved in 20 g water under agitation. Then the calcium chloride solution was added to 400 g of 50% total solids coffee extract at 85° C. and mixed during 10 min under continuous high agitation, nitrogen was injected into the extract and the coffee extract was spray dried to create a dry coffee extract with entrapped gas.

Visual appearance and mouthfeel of the Ca-fortified instant coffee was judged by six non-trained panellists. Sensory evaluation of the coffee reconstituted with hot water showed good mouthfeel, body, smooth texture, and a good flavor with no off-flavors or undesirable aftertaste.

Coffee crema quality such as volume, stability and texture was found to be improved as compared to a reference without added calcium.

### Example 5

Calcium fortified self-foaming instant coffee powder was prepared by dissolving 97% pure calcium chloride-dihydrate (28.4 kg) in 49 kg water under agitation. The calcium chloride solution was added to 517 kg of 58% total solids coffee extract and mixed at 60° C. during 60 min under continuous high agitation. Nitrogen was injected into the extract and the Ca-fortified extract was spray dried.

Visual appearance and mouthfeel of the Ca-fortified instant coffee was judged by six non-trained panelists. Sensory evaluation of the coffee reconstituted with hot water showed good mouthfeel, body, smooth texture, and a good flavor with no off-flavors or undesirable aftertaste.

Coffee crema quality such as volume, stability and texture was found to be improved as compared to a reference without added calcium.

### Example 6

5.0 g of magnesium sulfate was dissolved in 20 g water under agitation. Then the magnesium sulfate solution was added to 400 g of 50% total solids coffee extract at 85° C. and mixed during 10 min under continuous high agitation, coffee aroma was added, and a mixture of carbon dioxide and nitrogen gases was injected, and then the Mg-fortified coffee extract was spray dried to create a dry coffee extract with gas entrapped therein.

Visual appearance and mouthfeel of the Mg-fortified instant coffee was judged by six non-trained panelists. Sensory evaluation of the coffee reconstituted with hot water showed good mouthfeel, body, smooth texture, and a good flavor with no off-flavors and undesirable aftertaste. Coffee crema quality such as volume, stability and texture was found to be improved as compared to a reference without added magnesium.

1. A coffee extract comprising at least 1 milligram of a multivalent ion per gram of coffee solids.

2. The coffee extract of claim 1 comprising between 10 milligram and 200 milligram of a multivalent ion per gram of coffee solids.

3. The coffee extract of claim 1, wherein the extract is a dried coffee extract

4. The coffee extract of claim 1, wherein the multivalent ion is selected from the group consisting of an ion of calcium, zinc, magnesium, iron, and combinations thereof.

5. The coffee extract of claim 1, wherein the multivalent ion is in a form selected from the group consisting of calcium oxide, calcium lactate, calcium hydroxide, calcium chloride, calcium carbonate, calcium gluconate, zinc sulfate, magnesium chloride, and a combination thereof.

6. A method of producing a coffee extract, comprising:
extracting coffee beans with water to obtain an aqueous coffee extract; and
adding a multivalent ion to the coffee extract in an amount of at least 1 milligram per gram of coffee solids.

7. The method of claim 6 comprising adding a multivalent ion to the coffee extract in an amount of between 1 milligram and 200 milligram per gram of coffee solids.

8. The method of claim 6 comprising drying the coffee extract after addition of a multivalent ion to produce a dry soluble coffee product.

9. The method of claim 6, wherein the multivalent ion is selected from the group consisting of an ion of calcium, zinc, magnesium, iron, and combinations thereof.

10. The method of claim 6, wherein the multivalent ion is added in a form selected from the group consisting of calcium oxide, calcium lactate, calcium hydroxide, calcium chloride, calcium carbonate, calcium gluconate, zinc sulfate, magnesium chloride, and a combination thereof.

11. A method for improving the foamability and/or the foam stability of a coffee extract comprising:
producing the coffee extract by extracting coffee beans with water to obtain an aqueous coffee extract; and
adding a multivalent ion to the coffee extract in an amount of at least 1 milligram per gram of coffee solids.
